(19) United States
(12) Patent Application Publication
(10) Pub. No.: US 2018/0153296 A1
(43) Pub. Date: Jun. 7, 2018

(54) BRUSH AND BRUSH HEAD HAVING A HANDLE AND A WATER PORT

(71) Applicant: Joseph McCormick, Homer Glen, IL (US)

(72) Inventor: Joseph McCormick, Homer Glen, IL (US)

(21) Appl. No.: 15/370,829

(22) Filed: Dec. 6, 2016

(51) Int. Cl. A46B 11/06; A46B 9/02; B25G 3/36; A46B 17/06

(52) U.S. Cl. CPC A46B 11/06; A46B 17/065; B25G 3/36; A46B 9/02

(57) ABSTRACT

A brush assembly comprises a top surface and a bottom surface. The bottom surface comprises a plurality of bristles extending substantially downward. The top surface includes a fitting to which a handle can be coupled as well as a wash port that can be coupled to a standard hose connection port. The wash port allows a user to easily wash the bottom of the brush head including the bristles.

### FIELD OF THE DISCLOSURE

The present disclosure generally relates to a brush that can be used for numerous purposes, such as cleaning flat surfaces, such as those present on office or school floors, cleaning the inside of dirty containers, such as garbage cans, or other purposes. More specifically, the disclosure relates to a brush having a handle as well as a water port.

### BACKGROUND

Brushes are well known in the art, having been utilized for hundreds, or even thousands of years. There are numerous variations on brushes, ranging from toothbrushes (or even smaller devices) to large brushes (often called brooms) used to sweep debris from floors, and numerous sized brushes in between, such as hair brushes, and brushes used to clean out mid-sized or larger garbage cans. This disclosure is concerned with brushes with handles that are used to clean things, such as floors or the interior surface of a garbage can.

A typical brush will comprise a long straight handle, a brush head coupled to one end of the handle and disposed so as to have a top side and a bottom side, and a number of straight stiff bristles protruding outwardly from the cleaning surface (typically the bottom side of the brush head). In most applications, the handle will be set at an angle from the top side of the brush head. Brush heads can be rectangular or rounded in shape depending on the application, with rectangular heads often used for brooms and rounded heads often used for cleaning inside of containers so as to avoid having a sharp edge damage the interior of the container.

With regards to brooms, most brooms will comprise a long wooden handle with a male threaded portion at the end, and a removable brush head that will incorporate a female threaded fitting on its top side. This allows the head to be easily changed out when worn, or if a different brush head would serve a particular purpose better. In addition, such brush heads tend to be quite inexpensive.

Brushes are often used along with water sources to clean. Prior art cleaning brushes have coupled to a water source through piping disposed within the handle of the brush. However, this has the disadvantage of making the brush head significantly more expensive, as it must couple with a specialized delivery handle. This also makes it more difficult to swap out one brush head for another that may be better suited to a specific task, or that may have less wear. Moreover, such prior art brushes have an inherent weakness; namely that rigid piping is disposed in the handle. As the handle is regularly subjected to substantial stresses during regular use, damage to the handle, and the pipe contained within, can regularly occur. In addition, water will remain within the pipe after use. As the prior art cleaning brush is likely stored in a user's garage, the water left in the pipe can lead to dry rot in extreme heat and cracks during winter.

### OBJECTS OF THE DISCLOSED BRUSH AND BRUSH HEAD

One object of the disclosure is to provide an improved brush and brush head.

Another object of the disclosure is to provide a brush and brush head having both a handle fitting and a wash port.

Another object of the disclosure is to provide a low-cost brush and brush head having both a handle fitting and a wash port.

Another object of the disclosure is to provide a brush and brush head with a wash port that has a high lifespan and low cost.

Other advantages of this disclosure will be clear to a person of ordinary skill in the art. It should be understood, however, that a system or method could practice the disclosure while not achieving all of the enumerated advantages, and that the protected disclosure is defined by the claims.

### SUMMARY OF THE DISCLOSURE

An improved brush assembly is disclosed and claimed. Essentially, the brush assembly comprises a brush head having a bottom surface, a top surface, and a plurality of side walls. A plurality of bristles extend generally downward from the bottom surface. A wash port is mounted on the top surface, and is adapted to couple with a standard hose connector using a connection port formed into the wash port.

In a second embodiment of the disclosed brush assembly, the brush head further includes a fitting disposed on the top surface of the brush head that is adapted to engage a handle, such as a standard wooden handle with male threads on the external surface of the bottom of the handle.

In an additional embodiment of the disclosed brush assembly, the wash port further comprises a nozzle that is disposed on the interior of the top surface of the brush head so that water is sprayed downwards through the brush head, including through the bristles and a number of wash holes formed in the bottom surface of the brush head.

### BRIEF DESCRIPTION OF THE DRAWINGS

Although the characteristic features of this disclosure will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is an elevational view showing a broom type brush constructed in accordance with the present disclosure;

FIG. 1a is a bottom view depicting the bottom of a portion of a brush head constructed in accordance with the present disclosure;

FIG. 2 is an exploded, side elevational view of a wash port constructed in accordance with the disclosure; and

FIG. 3 is an elevational view of a hand type scrubbing brush constructed in accordance with the present disclosure.

### DETAILED DESCRIPTION

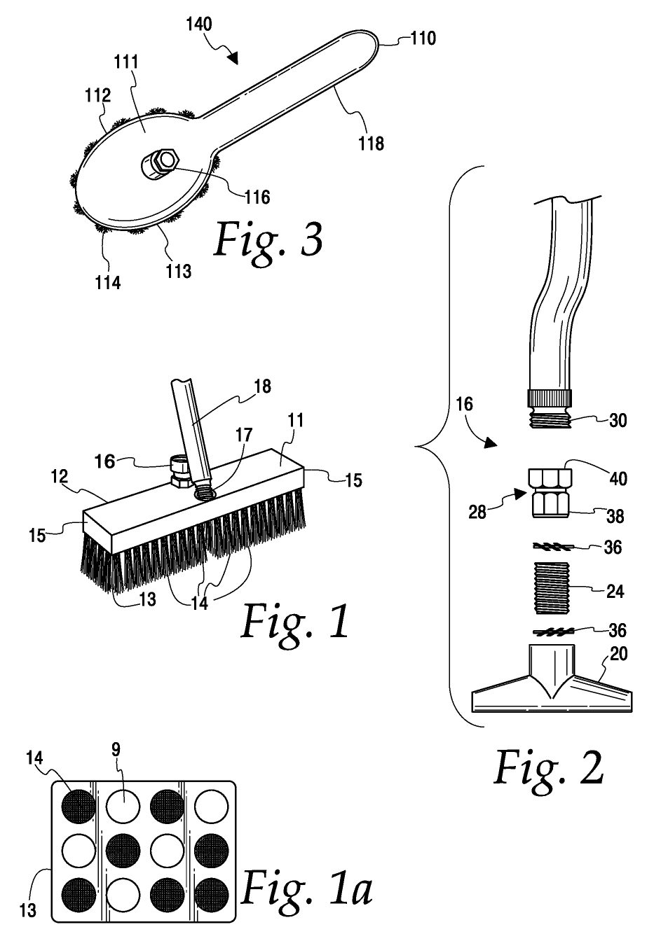

Turning to the figures, and to FIGS. 1 and 1a in particular, an improved brush assembly is illustrated and generally designated by the number 10. The disclosed brush assembly 10 includes a brush head with a top surface 11 and bottom surface 13; top and bottom surfaces 11 and 13 are substantially parallel to one another in this embodiment, and are joined by four side surfaces 15 that are generally orthogonal to the top and bottom surfaces 11 and 13. The bottom surface 13 incorporates a plurality of wash holes 9 as depicted in FIG. 1a. A handle 18 projects rearwardly and upwardly from a fitting 17 near the center of the top surface 11 of the brush head 12. The fitting 17 can be integrally formed into the brush head 12 or can be attached using, for example, a mounting plate (not shown), or some other means. Generally, the fitting 17 will incorporate internal female threads that are adapted to mate with external male threads present on the bottom end of the handle 18. The handle 18 can be easily removed from the brush head 12 by twisting the handle to unthread the handle 18 from the fitting 17 disposed on the brush head 12. A number of bristles 14 extend generally downward from the bottom surface 13 of the brush head. As depicted a number of separate bristle clusters 14 are depicted. However, the entire bottom surface 13 of the brush head could be substantially packed with bristles 14, or fewer bristles could be used, as long as space is left for some wash holes 9 to pass liquid, or the bristle placement is not entirely waterproof so that liquid can escape through the bristles.

In addition, the disclosed brush assembly 10 incorporates a wash port 16 disposed on the brush head 12. This wash port 16 allows a user to easily clean the brush head 12 including the bristles 14 by connecting a standard hose fitting (not shown in FIG. 1) to the wash port 16, running water through the wash port 16 which will spray it throughout the underside of the brush head 12 including through the wash holes 9 and bristles 14, which can be rubbed against a rough surface to loosen any debris, which will be washed away by the water flow. For example, a user can rub the bristles 14 of the brush head 12 against the lip of a garbage can while running water through the wash port 16 to eliminate and dispose of any debris. The wash port 16 also can be used to directly supply water or other liquid to aid in a cleaning project.

One possible construction of the wash port 16 is disclosed in FIG. 2. The wash port 16 is advantageously disposed on the top surface 11 of the brush head 12. As depicted, the wash port 16 can be angled so that water that is directed through the wash port will spray downwards throughout the entirety of the underside of the brush head 12 including through the bristles 14. However, it should be noted that the specific placement of the wash port 16 is not a limitation of this disclosure, and other placements could be used to obtain most advantages of the disclosure. The upper portion of the wash port 16 comprises a tee fitting 28. The tee fitting 28 further comprises the upper portion of the wash port 16, to which a water source can be coupled. The tee fitting 28 is adapted to sit on the top surface 11 of the brush head 12. The tee fitting 28 further includes a female threaded connection port 40 wherein the female threads are adapted to cooperate with the threads on a standard hose fitting 30. The tee fitting 28 also comprises a shoulder 38 which includes internal female threads (not shown). The internal female threads of the shoulder 38 are adapted to communicate with a pipe 24, which has external male threads. A lock washer 36 locks the shoulder 38 to the top portion of the pipe 24. The pipe 24 is adapted to pass through an aperture in the top surface 11 of the brush head 12. The bottom of the pipe 24 is coupled to a nozzle 20, and is locked in place with a lock washer 36. The nozzle 20 can be of any type; for example, a simple spreading nozzle that diffuses the flow of water throughout the entirety of the bottom surface 13 of the brush head 12 can be utilized. It should be noted that this particular construction is merely an example, and many alternative constructions of water ports could be used to implement the disclosed brush assembly. For example, a water port with an external shutoff valve could be used.

Particular embodiments of the disclosed improved brush and brush head have been described, and, in certain circumstances, specific embodiments have been set forth. Such description is intended to aid persons of skill in the art in practicing the disclosed improved brush and brush head without undue experimentation, rather than setting forth limitations on the scope of the claimed invention. For example, a broom type brush assembly has been disclosed above. However, in FIG. 4, a hand brush assembly 110 in accordance with the disclosure is illustrated. In particular, the hand brush 110 comprises a brush head 112 that comprises a top surface 111 and a bottom surface 113. The bottom surface 113 includes a number of downward facing bristles 114. On the top surface 111 a wash port 116 is disposed, which can be constructed as illustrated in FIG. 2. The wash port 116 can be coupled to a standard hose connector. In this embodiment, the top surface 111 and bottom surface 113 are directly coupled to one another, and can, for example, be generally convex in shape. Such a brush assembly 110 can be used, for example, to clean the interior of dirty containers such as garbage cans, etc.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It is intended that the scope of the disclosure not be limited by the specification, but be defined by the claims set forth below. In addition, although narrow claims may be presented below, it should be recognized that the scope of this invention is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional inventions are not dedicated to the public and the right to file one or more applications to claim such additional inventions is reserved.

What is claimed is:

1. A brush assembly comprising:
a) a brush head having:
i. a bottom surface;
ii. a plurality of bristles extending generally downward from the bottom surface;
iii. a top surface that is substantially parallel to the bottom surface, the top surface being coupled to the bottom surface; and
b) a wash port mounted on the exterior of the brush head, the wash port adapted to couple with a hose fitting.

2. The brush assembly of claim 1 further comprising:
a) a fixture disposed on the exterior of the top surface of the brush head, the fixture including internal female threads; and
b) a substantially straight handle including a bottom having external male threads, the handle being coupled to the fixture by the female threads of the fitting and the male threads of the handle.

3. The brush assembly of claim 1 wherein said wash port further comprises a nozzle, said nozzle being disposed on the interior of the top surface of the brush head.

4. The brush assembly of claim 3 wherein said wash port further comprises a connection port on the exterior of the top surface of the brush head, said connection port being adapted to couple with a hose fitting.

5. The brush assembly of claim 1 wherein the bottom surface of the brush head further comprises a plurality of wash holes.

6. The brush assembly of claim 1 further comprising four side surfaces that are disposed generally orthogonal to the bottom surface, the four side surfaces being coupled to the bottom surface and to the top surface, and wherein the bottom surface is coupled to the top surface through the four side surfaces.
